(19) United States
(12) Patent Application Publication
(10) Pub. No.: US 2023/0036663 A1
(43) Pub. Date: Feb. 2, 2023

(54) BRAKE PEDAL MODULE

(71) Applicant: ZF Active Safety GmbH, Koblenz (DE)

(72) Inventors: Christoph Beuerle, Koblenz (DE); Marcus Janson, Koblenz (DE); Peter Polke, Hanroth (DE)

(21) Appl. No.: 17/868,273

(22) Filed: Jul. 19, 2022

(30) Foreign Application Priority Data
Jul. 27, 2021 (DE) 102021119443.1

(51) Int. Cl. B60T 7/04; B60T 8/40

(52) U.S. Cl. CPC B60T 7/042; B60T 8/409

(57) ABSTRACT

A brake pedal module for a “brake-by-wire” brake system of a vehicle is disclosed. The brake pedal module has a carrier component for securing the brake pedal module on the vehicle, a brake pedal, which is mounted pivotably on the carrier component, and a damping unit, which is mechanically coupled at one end to the brake pedal and at the other end to the carrier component in order to produce a resistance when the brake pedal is actuated. The brake pedal module is a pre-assembled structural unit which is self-contained in terms of forces.

### CROSS-REFERENCE TO RELATED APPLICATION

This application claims priority to German Patent Application No. 102021119443.1, filed Jul. 27, 2021, the disclosure of which is incorporated herein by reference in its entirety.

### TECHNICAL FIELD

The disclosure relates to a brake pedal module for a “brake-by-wire” brake system of a vehicle.

### BACKGROUND

In the case of “brake-by-wire” brake systems, a braking intention of a driver is detected electronically, and the brakes of the vehicle are actuated by one or more purely electric actuators. For this purpose, provision can be made for each of the brakes of the individual wheels to be assigned an electric-motor actuator, as known, for example, in the case of an “EMB” (electric-motor brake). However, provision can also be made for an electrohydraulic actuator to be activated centrally in order to actuate the brakes hydraulically in a conventional manner, as known, for example, in an “IBS” (integrated brake system). Furthermore, a “brake-by-wire” brake system can be embodied as a hybrid system in that the brakes of one vehicle axle, for example those of the front wheels, are assigned to an “IBS” and the brakes of another vehicle axle, for example those of the rear wheels, are each embodied as an “EMB”.

Since in “brake-by-wire” brake systems there is generally no mechanical connection between a brake pedal and the brakes, a reaction behaviour of the brake pedal is simulated, e.g. hydraulically, for the driver. More precisely, a greater resistance acts with increasing travel when the brake pedal is actuated.

Although such hydraulic systems allow good simulation of a reaction behaviour of the brake pedal, they are complicated in terms of integration into a vehicle environment.

### SUMMARY

What is needed is a brake pedal module which can be integrated into a vehicle installation space in a particularly simple manner.

According to the disclosure, a brake pedal module for a “brake-by-wire” brake system of a vehicle is disclosed. The brake pedal module has a carrier component for securing the brake pedal module on the vehicle, a brake pedal, which is mounted pivotably on the carrier component, and a damping unit, which is mechanically coupled at one end to the brake pedal and at the other end to the carrier component in order to produce a resistance when the brake pedal is actuated. The brake pedal module is a pre-assembled structural unit which is self-contained in terms of forces.

Owing to the fact that the brake pedal module is a pre-assembled structural unit which is self-contained in terms of forces, an advantage is achieved in that the brake pedal module can be positioned in an installation space environment in a particularly simple manner. The components are held together in such a way that, apart from the securing of the structural unit on the vehicle, no additional mechanical support of some of these components on the vehicle is necessary owing to the structural unit being self-contained in terms of forces. Installation in the installation space is also simplified since only the carrier component has to be secured on the vehicle. Moreover, the brake pedal module can be of particularly compact design.

According to the disclosure, therefore, all the components of the brake pedal module are mounted on the carrier component.

The brake pedal can be formed by a strut, which, at a first end, has an actuating surface that can be actuated by a driver in order to signal a driver intention, and, at an end opposite the first end, is mounted in a pivot joint on the carrier component. In this way, the brake pedal can be suspended in a particularly simple manner from the carrier component.

In one exemplary arrangement, the damping unit is coupled to the brake pedal between the ends thereof. As a result, the brake pedal module can be designed to be particularly compact. Specifically, in this case, the damping unit is arranged in the space which is present in any case between the carrier component and the brake pedal, in order to allow an actuating movement of the brake pedal.

The damping unit is coupled to the brake pedal by an actuating tappet, for example, wherein the actuating tappet is mounted in an articulated manner on the brake pedal, in particular by a pivot joint or a ball-and-socket joint. As a result of the articulated connection between the actuating tappet and the brake pedal, a pivoting movement of the brake pedal can be converted into a purely linear movement of the actuating tappet.

According to one exemplary arrangement, the carrier component is shell-shaped, and a pivot axis for the brake pedal is mounted in opposite side wall sections, said pivot axis extending between the side wall sections. The shell shape consequently makes it possible to mount the pivot axis in a particularly simple manner. Moreover, the shape of the shell can be adapted particularly well to an installation space environment.

According to an alternative exemplary arrangement, the carrier component has a plate and at least one strut which extends from the plate, wherein the damping unit is secured on the plate and the brake pedal is mounted pivotably on the strut. Thus, both the damping unit and the brake pedal can be secured on the carrier component in a particularly simple manner.

For example, two struts extend parallel to one another from the plate of the carrier component, wherein the pivot axis of the brake pedal extends between the struts.

In one exemplary arrangement, there can be an aperture for the damping unit in the carrier component, and the damping unit can be inserted into the aperture, for example from a side of the carrier component which faces away from the brake pedal. Insertion into the aperture enables the damping unit to be aligned in a defined position on the carrier component. Particularly accurate positioning is achieved if the damping unit has a non-circular cross section and the aperture is shaped accordingly.

The damping unit is, for example, pneumatically self-contained. Specifically, a housing of the damping unit is pneumatically self-contained. A particular advantage here is that there are no fluid connections on the damping unit or no fluid lines need to be connected to the damping unit. Thus, the brake pedal module can be manufactured as a separate unit and positioned in an installation space environment independently of other components or fluid lines. Moreover, the damping unit can be particularly compact as a result.

According to one exemplary arrangement, the brake pedal module comprises a sensor unit for detecting a braking intention of a driver. In particular, a braking intention is detected electronically. Based on the detected braking intention, a signal can be forwarded to the actuators assigned to the wheels, which then generate a braking effect.

The damping unit can be mechanically coupled to the brake pedal in such a way that the damping unit is subjected to compression when the brake pedal is actuated. This makes possible the abovementioned, particularly space-saving arrangement of the damping unit between the brake pedal and the carrier component.

The brake pedal module according to the disclosure is suitable for use in a “brake-by-wire” brake system, which is may be equipped with “EMB” brakes and/or is designed as an “IBS” system.

### BRIEF DESCRIPTION OF DRAWINGS

Further advantages and features of the disclosure will become apparent from the following description and from the accompanying drawings, to which reference is made. In the drawings:

FIG. 1 shows schematically a brake pedal module according to the disclosure,

FIG. 2 shows a brake pedal module according to the disclosure in a perspective view,

FIG. 3 shows the brake pedal module according to the disclosure from FIG. 2 in a side view,

FIG. 4 shows the brake pedal module according to the disclosure from FIG. 2 in a front view,

FIG. 5 shows the brake pedal module according to the disclosure from FIG. 2 in a view from below,

FIG. 6 shows a section through a damping unit of the brake pedal module according to the disclosure,

FIG. 7 shows a perspective view of a brake pedal module according to the disclosure in accordance with another exemplary arrangement, and

FIG. 8 shows the brake pedal module from FIG. 7 in another view.

### DETAILED DESCRIPTION

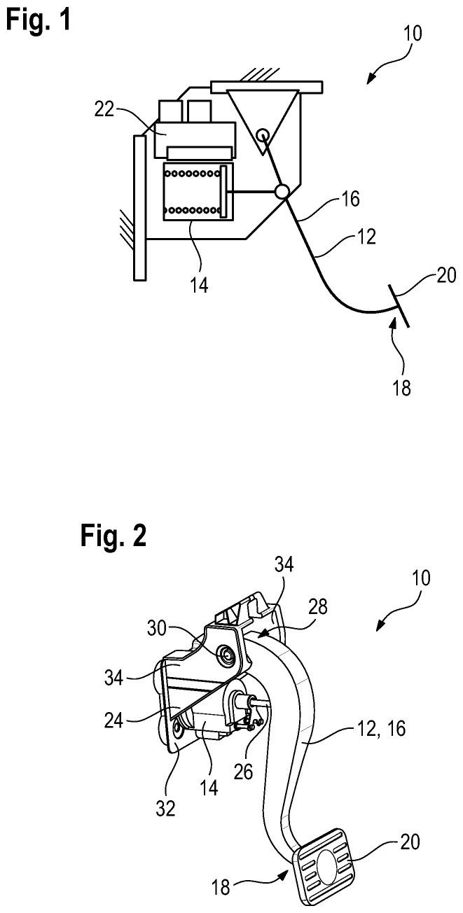

FIG. 1 shows schematically a brake pedal module 10 for a “brake-by-wire” brake system of a vehicle.

In particular, the brake pedal module 10 serves to electronically detect a braking intention of a driver.

The brake pedal module 10 comprises a pivotably mounted brake pedal 12 and a damping unit 14, which is mechanically coupled to the brake pedal 12. More precisely, the damping unit 14 is coupled to the brake pedal 12 between the ends thereof.

The damping unit 14 is used to generate a resistance when the brake pedal 12 is actuated.

When the brake pedal 12 is actuated, the damping unit 14 is subjected to compression.

The brake pedal 12 is formed by a strut 16.

At a first end 18, the strut 16 has an actuating surface 20, which can be pressed by a driver to signal a braking intention. In other words, a driver can exert a pressure on the actuating surface 20 with the foot to signal a braking intention.

The brake pedal module 10 furthermore comprises a sensor unit 22 for detecting a braking intention of a driver.

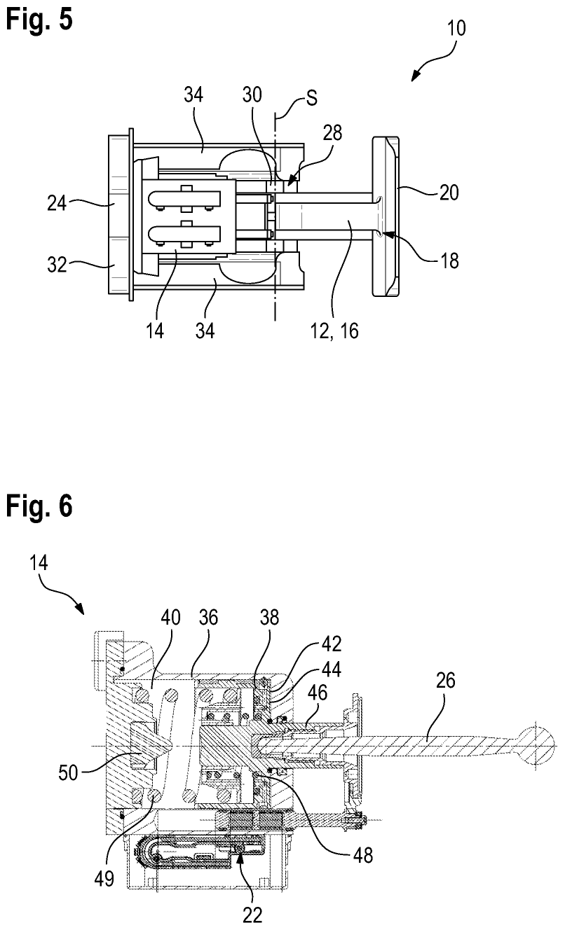

The structure of a brake pedal module 10 according to a first exemplary arrangement is described in detail below with reference to FIGS. 2 to 5, which show a brake pedal module 10 in various views.

The brake pedal module 10 has a carrier component 24, which is used to secure the brake pedal module 10 on the vehicle.

The other components of the brake pedal module 10 are pre-installed on the carrier component 24. This means that when the brake pedal module 10 is mounted in an installation space environment, only the carrier component 24 has be secured on the vehicle.

The brake pedal module 10 is a pre-assembled structural unit which is self-contained in terms of forces. This means that the brake pedal module 10 represents an independent, functional unit which is mounted on the vehicle as a whole, and in one exemplary arrangement, via the carrier component 24. If the brake pedal is moved in the uninstalled state outside the vehicle, it is possible to carry out all of its movements which are also possible in the installed state because the structural unit is already self-contained beforehand in terms of forces. Consequently, the brake pedal module 10 can be arranged in an installation space environment in a particularly simple and flexible manner.

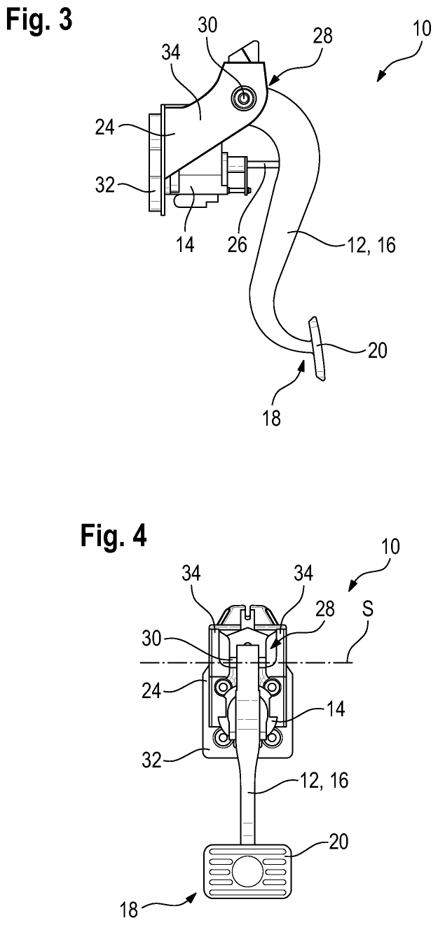

As can be seen in FIGS. 2 and 3, the damping unit 14 is mechanically coupled at one end to the brake pedal 12 and at the other end to the carrier component 24.

It can furthermore be seen from FIGS. 2 and 3 that the damping unit 14 is coupled to the brake pedal 12 by an actuating tappet 26. The actuating tappet 26 is mounted in an articulated manner on the brake pedal 12, e.g. by a pivot joint or a ball-and-socket joint.

The brake pedal 12 is pivotably mounted on the carrier component 24, namely by an end 28 opposite the first end 18.

More precisely, the brake pedal 12 is mounted on the carrier component 24 in a pivot bearing 30 (see FIG. 4).

In one exemplary arrangement, the carrier component 24 is formed in one piece, for example as an injection-moulded plastic part. However, a multi-part design is also conceivable.

According to the exemplary arrangement illustrated in FIGS. 2 to 5, the carrier component 24 has a plate 32 and two struts 34, which extend from the plate 32.

The struts 34 extend parallel to one another and are connected to one another at their ends remote from the plate 32. As a result, the carrier component 24 is particularly stable.

The brake pedal 12 is pivotably suspended between the struts 34, as can be seen particularly well in FIG. 4. In particular, a pivot axis S for the brake pedal 12 is mounted in the struts 34.

The damping unit 14 is secured, for example adhesively bonded or screwed, on the plate 32.

FIG. 6 illustrates a section through the damping unit 14.

The damping unit 14 comprises a housing 36, in which a piston 38 is accommodated and movably mounted.

The piston 38 divides the housing 36 into a pressure chamber 40 and a vacuum chamber 42.

A piston rod 46 extends from an end 44 of the piston 38.

The piston 38 is coupled to the brake pedal 12 via the piston rod 46 and the actuating tappet 26 resting against the piston rod 46.

Consequently, the piston 38 is moved in the housing 36 when the brake pedal 12 is actuated.

The sensor unit 22 detects a movement travel of the piston 38, whereby a braking intention of the driver is detected.

In the exemplary arrangement illustrated, a resistance during the actuation of the brake pedal 12 is generated by the damping unit 14 by elastic elements 48, 49, 50.

When moving the piston 38, a driver must apply a force to the brake pedal 12 in order to compress the elastic elements 48, 49, 50, and therefore the driver perceives a resistance at the brake pedal 12.

The elastic elements 48, 49 also serve as restoring elements to move the piston 38 back into its initial position after actuation of the brake pedal 12.

The housing 36 of the damping unit 14 is pneumatically self-contained.

The resistance perceived by the driver at the brake pedal 12 can also be generated by the damping unit 14 in some other way, for example by a pressure difference in the pressure chamber 40 and in the vacuum chamber 42.

It is more the arrangement of the damping unit 14 between the brake pedal 12 and the carrier component 24 which is decisive.

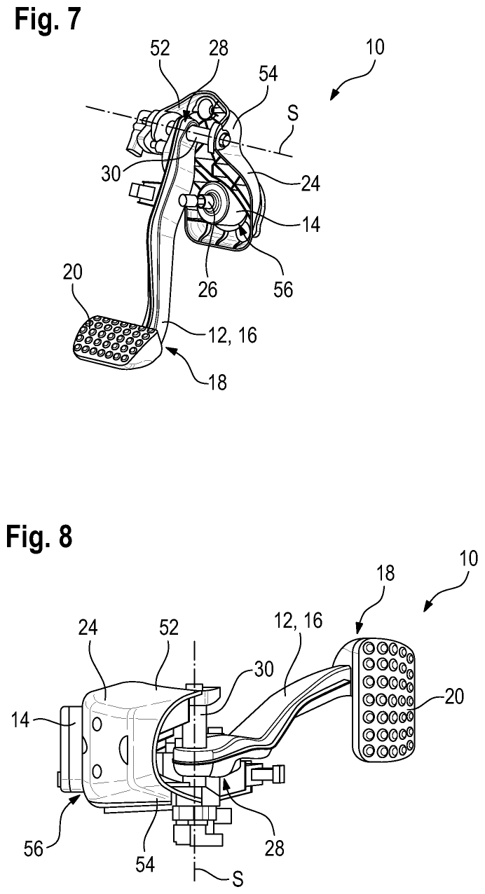

FIGS. 7 and 8 illustrate a brake pedal module 10 according to another exemplary arrangement.

The brake pedal module 10 illustrated in FIGS. 7 and 8 differs from the brake pedal module 10 according to FIGS. 2 to 5 in the shape of the carrier component 24.

In particular, the carrier component 24 is shell-shaped.

The pivot axis S for the brake pedal 12 is mounted in opposite side wall sections 52, 54. More precisely, the pivot axis extends between the side wall sections 52, 54.

Another difference is that there is an aperture 56 for the damping unit 14 in the carrier component 24, and the damping unit 14 is inserted into the aperture 56, more specifically from a side of the carrier component 24 which faces away from the brake pedal 12.

The damping unit 14 can then be screwed to the carrier component 24 from the rear, that is to say from that side of the carrier component 24 which faces away from the brake pedal 12.

Securing the damping unit 14 in this way has the advantage that the screw points are more easily accessible from the rear.

The securing of the damping unit 14 as shown in FIGS. 7 and 8 can, in principle, also be achieved in the case of the carrier component 24 illustrated in FIGS. 2 to 5 if there is a corresponding aperture in the plate 32.

1. A brake pedal module for a brake-by-wire brake system of a vehicle, comprising a carrier component for securing the brake pedal module on the vehicle, a brake pedal, which is mounted pivotably on the carrier component, and a damping unit, which is mechanically coupled at one end to the brake pedal and at the other end to the carrier component in order to produce a resistance when the brake pedal is actuated, wherein the brake pedal module is a pre-assembled structural unit which is self-contained in terms of forces.

2. A brake pedal module according to claim 1, wherein the brake pedal is formed by a strut, which, at a first end, has an actuating surface that can be actuated by a driver in order to signal a braking intention, and, at an end opposite the first end, is mounted in a pivot joint on the carrier component.

3. A brake pedal module according to claim 1, wherein the damping unit is coupled to the brake pedal between the ends thereof.

4. A brake pedal module according to claim 1, wherein the damping unit is coupled to the brake pedal by an actuating tappet, wherein the actuating tappet is mounted in an articulated manner on the brake pedal, in particular by one of a pivot joint or a ball-and-socket joint.

5. A brake pedal module according to claim 1, wherein the carrier component is shell-shaped, and a pivot axis for the brake pedal is mounted in opposite side wall sections, said pivot axis extending between the side wall sections.

6. A brake pedal module according to claim 1, wherein the carrier component has a plate and at least one strut which extends from the plate, wherein the damping unit is secured on the plate and the brake pedal is mounted pivotably on the strut.

7. A brake pedal module according to claim 1, wherein there is an aperture for the damping unit in the carrier component, and the damping unit is inserted into the aperture, from a side of the carrier component which faces away from the brake pedal.

8. A brake pedal module according to claim 1, wherein the damping unit (14) is pneumatically self-contained.

9. A brake pedal module according to claim 1, wherein the brake pedal module comprises a sensor unit for detecting a braking intention of a driver.

10. A brake pedal module according to claim 1, wherein the damping unit is mechanically coupled to the brake pedal in such a way that the damping unit is subjected to compression when the brake pedal is actuated.

11. A brake pedal module according to claim 1, wherein the damping unit is coupled to the brake pedal between the ends thereof.

12. A brake pedal module according to claim 11, wherein the damping unit is coupled to the brake pedal by an actuating tappet, wherein the actuating tappet is mounted in an articulated manner on the brake pedal by one of a pivot joint or a ball-and-socket joint.

13. A brake pedal module according to claim 12, wherein the carrier component is shell-shaped, and a pivot axis for the brake pedal is mounted in opposite side wall sections, said pivot axis extending between the side wall sections.

14. A brake pedal module according to claim 4, wherein the carrier component has a plate and at least one strut which extends from the plate, wherein the damping unit is secured on the plate and the brake pedal is mounted pivotably on the strut.

15. A brake pedal module according to claim 13, wherein there is an aperture for the damping unit in the carrier component, and the damping unit is inserted into the aperture, from a side of the carrier component which faces away from the brake pedal.

16. A brake pedal module according to claim 1, wherein the brake pedal module comprises a sensor unit for detecting a braking intention of a driver.

17. A brake pedal module according to claim 1, wherein the damping unit is mechanically coupled to the brake pedal in such a way that the damping unit is subjected to compression when the brake pedal is actuated.
